(19) United States
(12) Patent Application Publication
(10) Pub. No.: US 2010/0000133 A1
(43) Pub. Date: Jan. 7, 2010

(54) Article of manufacture for motivating users and method for using same

(76) Inventors: Madeleine Kent, Escondido, CA (US); Donald Beall MacElwee, JR., Temecula, CA (US)

Correspondence Address: HARRY V. MCGAHEY JR., 1532 SIXTH AVENUE, SAN DIEGO, CA, 92101, US

(21) Appl. No.: 12/217,404

(22) Filed: Jul. 3, 2008

(51) Int. Cl. G09F 7/18; G09F 13/18

(52) U.S. Cl. 40/124.02; 40/124.06

(57) ABSTRACT

An article of manufacture for motivating users and method for using same with a frame, a digital or fixed media insert, an image on the insert, one aperture anchored to the backing extending backwards from the rear side of the backing near one of the long edges of the backing, and another aperture anchored to the backing extending backwards from the rear side of the backing near one of the short edges of the backing. A clip assembly can be use either as stand for the frame when sifting on a horizontal surface or a clip to clip the frame to a non-horizontal surface such as a vehicle air conditioning vent.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of motivational devices and more specifically to an article of manufacture for motivating users and method for using same.

There is always a need for improved systems and methods to assist individuals to become motivated and inspired, and to remain so until specific goals are met. Many goal achievement systems rely upon repeated exposures to goals, either in words or images, so that the unconscious mind can begin to incorporate the positive affirmations into itself, thereby manifesting in the outward achievement of the goal(s) sought. In addition, repeated exposure to inspirational messages is believed by many to motivate and place individuals into a better frame of mind to take on their day.

There are many products on the market designed to help achieve this purpose, such as books, bumper stickers, motivational tapes, religious placards, stickers, bookmarks, etc. Most people spend at least 30 minutes in their automobile every day. Most of these people look at the bumper stickers that other people put on their cars, and put bumper stickers on the rear of their own cars, but do not have anything within their own vehicle for the purpose of motivating or inspiring themselves. The system described herein allows continuous exposure to images and phrased goals both in an individual's vehicle, and when one is near any flat surface indoors, such as a desk or a table.

Relevant art includes US patent application number 2007/0075159 1A (Apr. 5, 2007 Lin) which is an air freshener that has the ability to clip onto an automobile air vent.

U.S. Pat. No. 6,163,997 (Dec. 26, 2000 Deralas) discloses a vehicle-mountable picture frame. Various types of attachment means are disclosed but none are similar to the subject invention herein described which can also allow the frame to stand by itself on a table or desk.

U.S. Pat. No. 6,125,566 (Oct. 3, 2000 McLaughlin) and U.S. Pat. No. 6,029,384 (Feb. 29, 2000 McLaughlin) disclose picture frames for mounting a picture on an automobile dashboard using a pivotal U-shaped supporting member on the backside.

U.S. Pat. No. 4,993,177 (Feb. 19, 1991 Hudson) discloses a frame for a picture which can be mounted on a dashboard or hung from a rearview mirror.

U.S. Pat. No. 4,814,212 (Mar. 21, 1989 Spector) discloses an automobile air freshener unit which can hold a picture.

U.S. Pat. No. 4,432,152 Feb. 21, 1984 Daenen) discloses a picture frame arrangement using a modular concept and a mounting unit which can be mounted on a wall or used as a stand, but does not contemplate the ability to attach to the inside of an automobile air vent.

U.S. Pat. No. 4,391,053 for a (Jul. 5, 1983 Anthony) shows a visor picture frame to attach to the sun visor of an automobile.

None of the forgoing art discloses a clip which can attach the display to an automobile air vent and which can also be used as a stand to display the message on a table or desk top when not clipped to the grill of the air vent. Also none of the foregoing can display both in both landscape style and portrait style orientations when standing the frame up on a horizontal surface like a table or desk.

### BRIEF SUMMARY OF THE INVENTION

The primary object of the invention is to provide a better motivational device that is easily movable and that can easily be kept in front of the user at all times during waking hours, whether the user is in a vehicle, a boat, or indoors.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for motivating users and method for using same comprising: a frame having a rectangular shape and a front and a back side, two of the perimeter sides of the rectangular frame being longer than the other two, a fixed media insert made up of either a media image encased in a transparent cover with a hard backing or a digital or computer generated image, the fixed media insert being sandwiched inside the front frame and on top of the rectangular backing, fitting between a plurality of pins anchored at 90 degree angles to the plane of the frame inside the perimeter of the frame extending towards the rear of the perimeter of the frame, a rectangular backing with two of the perimeter sides being longer than the other two, the backing being placed underneath the image, a first aperture in the backing opening towards the rear side of the backing near one of the long edges of the backing, a second aperture in the backing opening towards the rear side of the backing near one of the short edges of the backing, a flexible clip, the top and bottom members of the flexible clip each having a top and a bottom surface. The bottom surface of the clip being wide enough to form a stable stand for the frame when placed on a horizontal surface, the top member of the clip being smooth on its bottom surface, the bottom member of the clip being serrated on the top surface, a pin on one end of the flexible clip which will fit snuggly into either of the aperatures opening towards the rear side of the backing.

In accordance with another preferred embodiment of the invention, each aperture has four short fins extending at 90 degree intervals out from the center of each aperture, the four fins forming an “x” shaped design with each aperture being at the center of each “x”, and a flexible clip, the flexible clip having a top flange and a bottom flange such that when the pin is anchored into either of the apertures, the top and bottom flange engages the four short fins so as to prevent rotation of the clip.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention from the back with the clip attached for landscape view.

FIG. 2 is an elevational view of the invention from the back with the clip attached for landscape view.

FIG. 3 is an elevational view of the invention from the side with the clip attached for landscape view.

FIG. 4 is a top view of the invention with the clip attached for landscape view.

FIG. 5 is a perspective view of the invention from the front.

FIG. 6 is a perspective view of the frame from behind.

FIG. 7 is a perspective view of the invention from the front.

FIG. 8 is a perspective view of the backing of the invention.

FIG. 9 is a perspective view of the clip.

FIG. 10 is an elevational view of the clip from the side.

FIG. 11 is a perspective view of the clip.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### LISTING OF PARTS OF THE DEVICE

fixed media insert (11)
front frame (12)
pins (13)
rectangular backing (14)
bottom member of the clip (15)
partially circular spring means (16)
snap assist flange (17)
top member of the clip (18)
bull nose (19)
landscape view aperture (20)
bottom anchor flange (21)
top anchor flange (22)
peg (23)
portrait view aperture (24)
portrait view fins (25)
flexible clip assembly (27)
pin receiving orifices (28)
landscape view fins (29)

Turning first to FIG. 1 there is shown a perspective view of the article of manufacture for motivating users from the back with the clip (27) attached in the landscape view position. In this position the device could either be attached to a vehicle air vent, or it could be used to stand up on a flat surface. One of the great advantages of the device is that the clip can serve as either as a stand to place and hold up the frame on a horizontal surface, or it can be used as a clip on means to clip the frame to a non-horizontal surface such as a vehicle air vent. The clip (27) is split into two halves so as to accommodate any vertical post in the middle of a vehicle's air vent. The front frame (12) having a rectangular perimeter and the rectangular backing (14) forming the back side can also be seen. In the preferred embodiment, two of the perimeter sides of the rectangular frame are longer than the other two. A fixed media insert (11), is made up of either a media image encased in a transparent cover with a hard backing or a digital or computer generated media image without a transparent cover. The fixed media insert (not visible) is sandwiched between the front frame (12) and the rectangular backing (14), fitting perfectly between the plurality of pins (not visible) extending backwards at a 90 degree angle from the axis of the frame from the rear of the perimeter of the frame which fit into an equal number of pin receiving orifices (28). A portrait view aperture (24) can be seen extending backwards towards the rear of the device from the rear side of the backing (14) near one of the short edges of the backing. The portrait view aperture (24) has four short portrait view fins (25) extending at 90 degree intervals out from the center of the aperture, the four fins forming an “x” shaped design with each portal being at the center of each “x”. The flexible clip assembly (27) has a top member (18) and a bottom member (15) anchored to a partially circular spring means (16) at one end. In the preferred embodiment the top member (18) of the flexible clip (27) has a snap assist flange (17) extending away from the bottom member (15) on the end opposite of the spring means and the bottom member of the flexible clip (27) has a rounded bull nose (19) shape on the end opposite to the spring means. The top and bottom members of the flexible clip each have a top and a bottom surface. The top member of the clip (18) being smooth on both of its top and bottom surfaces while the bottom member of the clip (15) being serrated on the top surface and smooth on the bottom surface. A peg (not visible) which will fit snuggly into either of the portrait or landscape apertures extends backwards from the rear side of the backing, the peg is hidden in FIG. 1 but is actually anchored to the top of the spring means and inserted into the landscape portal (not visible) underneath it. A top flange (22) and a bottom flange (21) are anchored to the periphery of the partially circular spring means (16) such that when the peg (not visible) is anchored into either the landscape or portrait aperture, the top flange (22) and the bottom anchor flange (21) engages the distal ends of the four short fins beneath them so as to prevent rotation of the clip assembly (27) when connected to either aperture. The clip assembly (27) is wide enough to form a stable stand when the device is used by placing it on a table, desk or other horizontal surface.

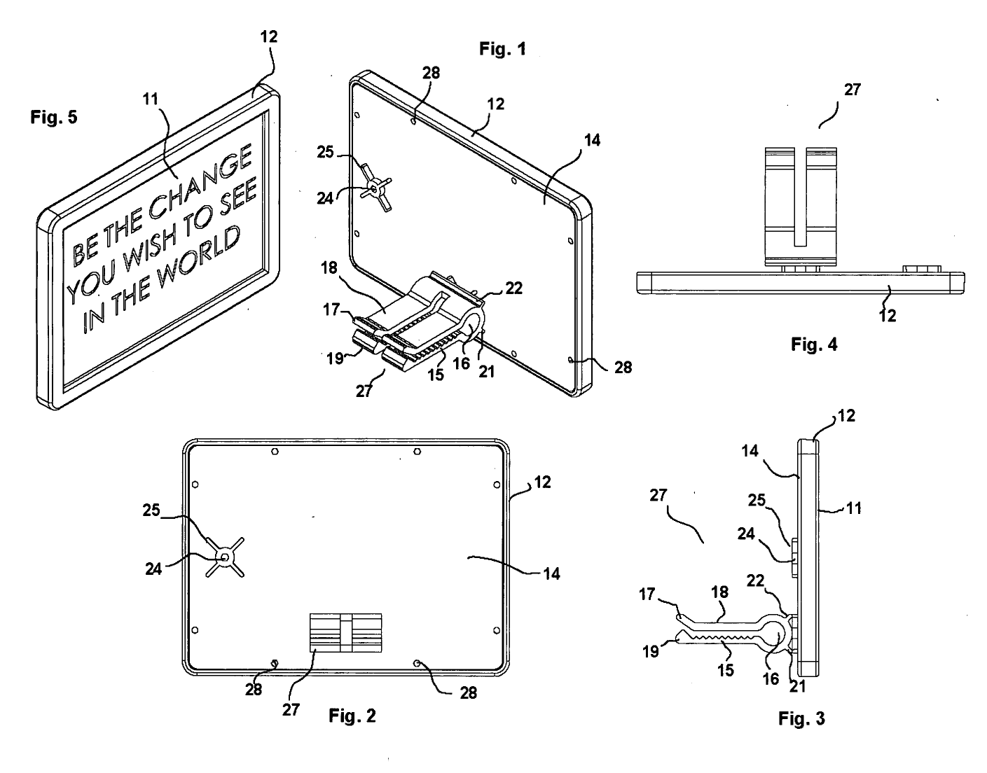

FIG. 2 is an elevational view of the invention from the back with the clip assembly (27) attached for landscape view. The backing (14) inside the frame (12) is seen with the plurality of pin receiving orifices (28) around its edges and the portrait aperture (24) extending out of the backing (14) with the four portrait view fins (25) in place. The plurality of pin receiving orifices (28) on the backing match the plurality of pins (not visible) extending rearwards at a 90 degree angle to the axis of the perimeter of the frame (12). In the preferred embodiment the ends of the pins would be visible through the pin receiving orifices (28). Also any other attachment means could be used to nest the pins into the orifices.

FIG. 3 is an elevational view of the invention from the side with the clip (27) attached for landscape view. The frame (12) with a transparent front cover (11) is in place. The portrait aperture (24) with the portrait view fins (25) sticking out of the back (14) are visible. The top flange (22) anchored to the landscape portal and its fins is visible along with the bottom anchor flange (21). The bottom member of the clip (15) with its serrated edge on the upper side is visible. The bull nose (19) in conjunction with the snap assist flange (17) makes it easy to slide the device onto the vanes of a vehicle air vent. The spring means which in the preferred embodiment is comprised of a partially circular spring means (16) with the top flange (22) and bottom anchor flange (21) is also shown.

FIG. 4 is a top view of the invention with the clip attached for landscape view. In the preferred embodiment, the clip assembly (27) is split into two parts or sections to give greater flexibility to the assembly and to allow it to go over any vertical spine which may be present down the center of a vehicle air vent. The top of the front frame (12) is also visible.

FIG. 5 is a perspective view of the invention from the front showing an example of a motivational image used for motivating the user behind the transparent cover (11). In the preferred embodiment the image is pre mounted and sealed permanently behind the transparent cover in the assembled device, but there does not need to be a transparent cover. The motivating image can be a single word, a plurality of words, a picture or plurality of pictures, a single image or a plurality of images, or any combination of these. The image can be a digital or computer generated image, or can use some other conventional imprinting or lettering means or method. The image can also be generated by an electronic means such as a computer or a programmed electronic device capable of generating an image or images. Any sealing method means can be used to seal the image inside the device. Also, the device need not be a motivational lettered message, but can be any type of visual image.

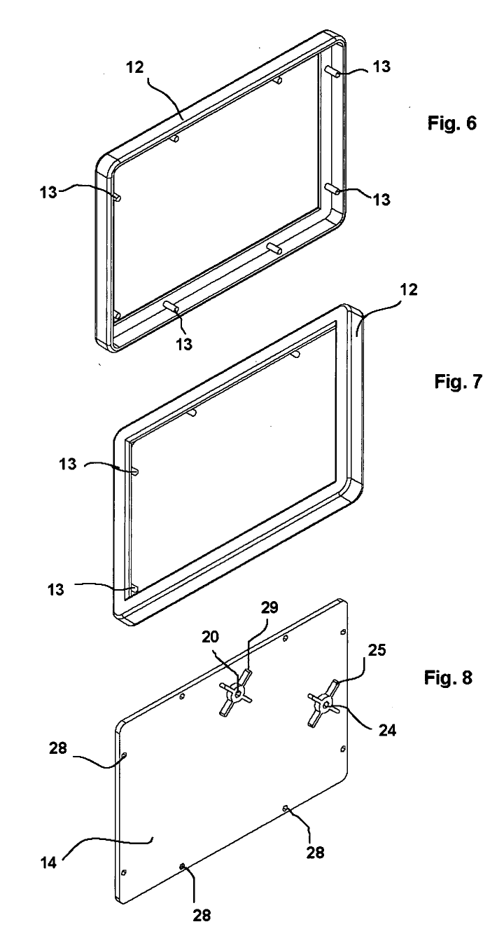

FIG. 6 is a perspective rear view of the front frame (12) showing the plurality of pins (13) which extend at a 90 degree angle from the axis of the front frame (12) towards the back of the device used in the preferred embodiment to anchor the frame (12) to the back (not shown).

FIG. 7 is a perspective front view of the front frame (12) showing the plurality of pins (13) extending towards the back of the device.

FIG. 8 is a perspective view of the backing (14) of the invention. The four landscape view fins (29) surrounding the landscape aperture (20) are shown at the top of the rectangular backing (14). The portrait aperture (24) inside the portrait view fins (25) are also visible. The plurality of pin receiving orifices (28) on the backing (14) can be seen prior to having the pins inserted from the front frame.

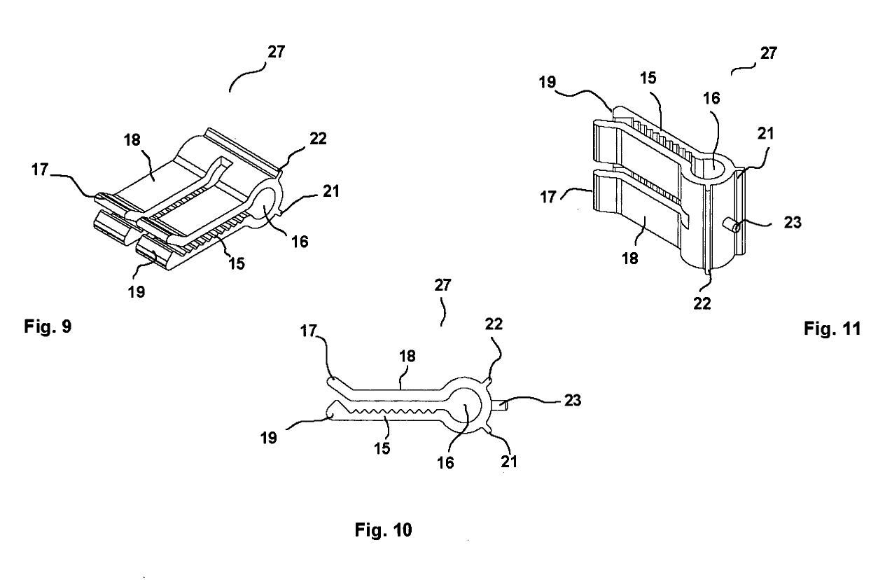

FIG. 9 is a perspective view of the clip assembly (27). The top member of the clip (18) is visible attached to the snap assist flange (17) which makes it easy to snap onto a vehicle vent. The serrated upper side of the bottom member of the clip (15) assists in holding the device tightly onto the vent when it is used in a vehicle. The bull nose (19) makes slipping the entire unit easily onto the slat or slats of an air vent or any slat style portion of a vehicle or other vertical surface. In the preferred embodiment, the clip is split in two to allow it to fit over any vertical spine which may be present down the center of an automobile or other vehicle air vent. The preferred embodiment of the partially circular spring means (16) with the top anchor flange (22) and the bottom anchor flange (21) are also visible.

FIG. 10 is an elevational view of the clip assembly (27) from the side. The peg (23) which inserts either into the landscape portal or the portrait portal (24) is most clearly shown in this figure. The preferred embodiment of the partially circular spring means (16) with the top anchor flange (22) and the bottom anchor flange (21) are also visible, as are the top member of the clip (18) attached to the snap assist flange (17) and the serrated upper side of the bottom member of the clip (15) along with the bull nose (19).

FIG. 11 is a perspective view of the clip assembly (27) which gives the best view of the bottom anchor flange (21) and the top anchor flange (22) next to the peg (23) at the point of attachment on the partially circular spring means (16) of the clip assembly (27). In the preferred embodiment, the peg (23) is anchored to the top of the partially circular spring means (16) and is extending outwards from the distal most point of the spring means (16) relative to the anchor points of the top member of the clip (18) and bottom member of the clip (15). In the preferred embodiment, the top anchor flange (22) and a bottom anchor flange are anchored to the periphery of the spring means such that when the peg is anchored into either of the portals, the top anchor flange (22) and the bottom anchor flange (21) engage the four short fins around the apertures (not shown) so as to prevent rotation of the clip when connected to the back of the device. Also, in the preferred embodiment, the top and bottom members of the clip are split vertically into two separate sections at the point of attachment to the peg so as to allow the clip to engage around any vertical post in the middle of a vehicle's air vent.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of manufacture for motivating users and method for using same comprising:
a frame comprised of a rectangular perimeter and a front and a back side;
two of the perimeter sides of the rectangular frame being longer than the other two;
a fixed media insert anchored to the front side of the frame;
an image on the fixed media insert;
a rectangular backing with two of the perimeter sides being longer than the other two;
the backing underneath the image;
an aperture in the backing opening outwards from the rear side of the backing near one of the long edges of the backing;
an aperture in the backing opening outwards from the rear side of the backing near one of the short edges of the backing;
a flexible clip;
the top and bottom members of the flexible clip each having a top and a bottom surface;
The bottom surface of the clip being wide enough to form a stable stand for the frame when placed on a horizontal surface;
the top member of the clip being smooth on its bottom surface;
the bottom member of the clip being serrated on the top surface;
a peg on one end of the flexible clip which will fit snuggly into either of the apertures opening outwards from the rear side of the backing.

2. An article of manufacture for motivating users and method for using same as claimed in claim 1 wherein the top member of the clip is serrated on its bottom surface.

3. An article of manufacture for motivating users and method for using same as claimed in claim 1 wherein the top and bottom members of the clip are split vertically into two separate sections at their point of attachment so as to allow the clip to fit around any vertical post in the middle of a vehicle's air vent.

4. An article of manufacture for motivating users and method for using same as claimed in claim 1 wherein the frame has a plurality of decorations on it.

5. An article of manufacture for motivating users and method for using same as claimed in claim 1 wherein the frame is illuminated.

6. An article of manufacture for motivating users and method for using same as claimed in claim 1 wherein the clip is mounted into a vehicle air vent.

7. An article of manufacture for motivating users and method for using same as claimed in claim 1 wherein the clip is mounted on any slat style item allowing a clip means of attachment.

8. An article of manufacture for motivating users and method for using same as claimed in claim 1 wherein the clip is used as a stand to hold up the frame on a flat surface.

9. An article of manufacture for motivating users and method for using same as claimed in claim 1 wherein the image is sealed permanently by a sealing means where the fixed media insert is sandwiched between a clear front cover and the backing.

10. An article of manufacture for motivating users and method for using same as claimed in claim 1 wherein the image is comprised of a single word.

11. An article of manufacture for motivating users and method for using same as claimed in claim 1 wherein the image is comprised of a plurality of words.

12. An article of manufacture for motivating users and method for using same as claimed in claim 1 wherein the image is comprised of a single visual image.

13. An article of manufacture for motivating users and method for using same as claimed in claim 1 wherein the image is comprised of a plurality of visual images.

14. An article of manufacture for motivating users and method for using same as claimed in claim 1 wherein the image is comprised of both a plurality of words and a plurality of visual images.

15. An article of manufacture for motivating users and method for using same as claimed in claim 1 wherein the image is generated by an electronic means.

16. An article of manufacture for motivating users and method for using same as claimed in claim 1 further comprising:
a plurality of pins extending backwards at a 90 degree angle from the axis of the frame from the rear of the perimeter of the frame;
a plurality of pin receiving orifices on the backing matching the plurality of pins extending backwards from the rear of the perimeter of the frame;
and the plurality of pins extending backwards from the rear of the perimeter of the frame being nested into the plurality of orifices on the backing.

17. An article of manufacture for motivating users and method for using same as claimed in claim 1 further comprising
each aperture having four short fins extending at 90 degree intervals out from the center of each aperture;
the four fins forming an “x” shaped design with each aperture being at the center of each “x”;
the top and bottom members of the clip contain a top flange and a bottom flange anchored to the periphery of the clip means such that when the peg is anchored into either of the apertures, the top anchor flange and the bottom anchor flange engage the fins around the apertures so as to prevent rotation of the clip when connected to the back of the device.

18. An article of manufacture for motivating users and method for using same as claimed in claim 17 further comprising:
each aperture having a plurality of fins extending out from the center of each portal;

19. An article of manufacture for motivating users and method for using same as claimed in claim 1 further comprising
the flexible clip having a top and a bottom member anchored to a partially circular spring means at one end;
the top member of the flexible clip having a flange extending away from the bottom member on the end opposite to the spring means; and
the bottom member of the flexible clip having a rounded bull nose shape on the end opposite to the spring means.

20. An article of manufacture for motivating users and method for using same comprising:
a frame having a rectangular perimeter and a front and a back side;
two of the perimeter sides of the rectangular frame being longer than the other two;
a media insert anchored to the front side of the frame;
an image on the media insert;
a rectangular backing with two of the perimeter sides being longer than the other two;
the backing underneath the image;
a plurality of pins extending backwards from the rear of the perimeter of the frame;
a plurality of orifices on the backing matching the plurality of pins extending backwards from the rear of the perimeter of the frame;
an aperture extending backwards from the rear side of the backing near one of the long edges of the backing;
an aperture extending backwards from the rear side of the backing near one of the short edges of the backing;
each portal having four short fins extending at 90 degree intervals out from the center of each portal;
the four fins forming an “x” shaped design with each portal being at the center of each “x”;
a flexible clip divided into two halves so it will fit around a vertical post;
the flexible clip having a top and a bottom member anchored to a partially circular spring means at one end;
the top member of the flexible clip having a flange extending away from the bottom member on the end opposite to the spring means;
the bottom member of the flexible clip having a rounded bull nose shape on the end opposite to the spring means;
the top and bottom members of the flexible clip each having a top and a bottom surface;
the top member of the clip being smooth on both of its top and bottom surfaces;
the bottom member of the clip being serrated on the top surface and smooth on the bottom surface;
a peg which will fit snuggly into either of the portals extending backwards from the rear side of the backing;
the peg anchored to the top of the spring means; and
a top flange and a bottom flange anchored to the periphery of the partially circular spring means such that when the peg is anchored into either of the apertures, the top and bottom flange engage the four short fins so as to prevent rotation of the clip connected to the back of the device.
